(19) United States
(12) Patent Application Publication
(10) Pub. No.: US 2009/0306951 A1
(43) Pub. Date: Dec. 10, 2009

(54) ARCHITECTURE FOR SUBSCRIBER SIMULATION ON AN ATN

(75) Inventors: Christophe Paletou, Castanet Tolosan (FR); Laurent Robert, Castelnaudary (FR); Christian Corniot, Le Plessis Robinson (FR)

Correspondence Address: LOWE HAUPTMAN HAM & BERNER, LLP, 1700 DIAGONAL ROAD, SUITE 300, ALEXANDRIA, VA, 22314, US

(73) Assignee: THALES, Neuilly Sur Seine (FR)

(21) Appl. No.: 11/721,137

(22) PCT Filed: Dec. 2, 2005
(86) PCT No.: PCT/EP2005/056426

§ 371 Date: Aug. 28, 2009

(30) Foreign Application Priority Data
Dec. 7, 2004 (FR) 0413022

(51) Int. Cl. G06G 7/62

(52) U.S. Cl. 703/13

(57) ABSTRACT

The present invention concerns the field of communication networks having a structure similar to an aeronautical telecommunications network (ATN). In particular, the invention relates in particular to how to simply simulate a large number of subscribers exchanging information via an ATN with equipment under test so as to test the ability of the equipment to exchange, via an ATN, information with a large number of subscribers. The inventive architecture comprises in particular a modified ATN stack enabling several separate communication channels to be opened on the ATN for a common application, said application being simultaneously implemented by several simulated entities. The modification of the ATN stack concerns in particular the assignment, by the corresponding ASE layers, of AEq identifiers to the applications implemented by the simulated entities. This modification also concerns the association of a network identifier T_{SEL} with an AEq identifier from a modified ASE layer.

### CROSS-REFERENCE TO RELATED APPLICATIONS

The present Application is based on International Application No. PCT/EP2005/056426, filed on Dec. 2, 2005, which in turn corresponds to France Application No. 0413022, filed on Dec. 7, 2004, and priority is hereby claimed under 35 USC §119 based on these applications. Each of these applications are hereby incorporated by reference in their entirety into the present application.

### SCOPE OF THE INVENTION

The present invention relates to the field of communication networks having a structure similar to Aeronautical Telecommunication Networks (ATN). The invention relates in particular to how to simply simulate a large number of subscribers exchanging information via an ATN with an equipment under test in order to test the ability of the equipment to exchange, via an ATN, information with a large number of subscribers.

### CONTEXT OF THE INVENTION

### Prior Embodiment

The ATN is designed to interlink the subnetworks or local-area networks, used by the various parties involved in the civil aviation field, including the air traffic control services, airline companies, aircraft, weather services or even airport services. The purpose of the ATN is to exchange data (control instructions, weather messages, flight parameters, position reports, passenger calls, etc.) in a way that is both reliable and powerful. The ATN is a still-emerging network, which implements determined message exchange protocols. The format of the messages exchanged, and the structure of the protocols used, are standardized by the International Civil Aviation Organization, known by the acronym ICAO. This standardization is formalized through the ISO 9705 standard and standards published by the ICAO and known as “Standard and Recommended Practices”, or SARPs. This standardization is based on the OSI network architecture model, an acronym standing for “Open System Interconnection”. The OSI model is that defined by the International Organization for Standardization, or ISO. The ATN can thus be defined as a network for exchanging data between aircraft and ground equipment or even between ground equipment and other ground equipment.

To satisfy the various applications considered, the SARP standards define a large number of OSI-type protocol stacks which take account of the network functionalities necessary to the various functional entities that make up the ATN, such as, for example, the air terminals or even the routers or Ground Boundary Intermediate Systems (GBIS).

According to the SARPs, each element intended to operate as a separate ATN entity is interfaced with the ATN by means of a single protocol structure called ATN stack, configured appropriately. An element is considered to be a separate ATN entity if it has its own address on the network, as is for example the case with air terminals or AESs, GBISs, or even ground terminals or GESs.

In the air traffic domain, the ATNs, despite being still emerging, are considered to be the standard that must be applied to the new telecommunications infrastructures and, more generally, information exchange infrastructures, such that the new ground-based air traffic control systems must, for example, be able to use the ATNs to supervise all the traffic included in their coverage area, or flight information region (FIR), to use the proper term.

For obvious reasons of dependability, it is therefore necessary to be able to perform full-scale tests on the equipment being developed before it is put into operational service. Similarly, when setting up an ATN, it is necessary to check that the infrastructure elements of this network are indeed correctly configured. However, like many communication networks, an ATN in operational service carries a very heavy communication stream.

If we look in particular at the control system which manages an air traffic coverage area, it can be seen that the number of parties that communicate with the control system via the network is very large. These parties, which constitute network entities, are in particular the aircraft maneuvering in the area covered by the system, and the number of which can commonly approach around a thousand.

To test the performance characteristics of such a control system, and in particular its capacity to manage several hundred communications via an ATN, it is necessary to have means of simulating several hundred parties, or network entities, that communicate with the system, each network entity being interfaced with the network by its own ATN stack and being identified by a particular network address, as in the case of real parties. It can therefore be seen that such a test raises serious implementation problems. Also, at the present time, the SARP recommendations of the ICAO do not include any explicit recommendations concerning how to implement tests, or the structure of the simulation means to be employed.

The only solution currently envisaged for implementing a reliable test consists in implementing as many simulation means as there are network entities to be simulated, each simulation means comprising an ATN stack for interfacing it with the network to which the system under test is connected, the stacks being linked to computation means used to implement the simulation. This solution, which is costly and difficult to implement, often leads to having to limit the simulation to fewer network entities than there are in reality and therefore a less comprehensive test. Such a solution has, moreover, to date not been materialized by an implementation.

Moreover, no other solution has been proposed with which to test the capacity of a system to exchange information safely, via an ATN, with a large number of network entities.

### PRESENTATION OF THE INVENTION

To overcome the problem stated above and implement a test that is both exhaustive and can be implemented at reasonable cost, the solution proposed by the applicant consists in developing a simulation means having a specific architecture enabling it to simulate a plurality of parties, or network entities, through a single network interface. To this end, the inventive architecture comprises in particular a modified ATN stack making it possible advantageously to open several different communication channels on the ATN for one and the same application, this application being implemented by a number of entities simulated simultaneously. The modification of the ATN stack relates in particular to the ULCS and ASE upper layers.

According to the invention, each application is associated at the network level with a unique identifier and each network identifier corresponds to a unique application.

According to the invention, the modified ATN stack advantageously comprises modified ASE application layers for interfacing several applications of the same type j, each application being implemented by a given simulated entity i, a modified ASE layer assigning each application j implemented an identifier AEq(i, j) dependent on the application j implemented and the simulated entity i that is implementing it.

According to the invention, the modified ATN stack has the advantage of comprising a modified ULCS application layer for setting up the associations of the application identifiers AEq(i, j) with network identifiers T_{SEL}(i, j), each identifier T_{SEL}(i, j) corresponding on a one-to-one basis to the corresponding identifier AEq(i, j).

According to the invention, the modified ULCS layer uses a database parameterized by the identifier i of the simulated entity and the identifier j of the application concerned. This database can advantageously have a size that is variable according to the complexity of the simulation sequence carried out.

This modified ATN stack therefore advantageously makes it possible to simulate, with a single protocol structure, a plurality of parties, or network entities, such as aircraft, each network entity being able to open a number of communication channels through the ATN.

It also makes it possible to comply with the protocol standards of the ATN and, consequently, not affect the normal operation of the network. It thus makes it possible to perform tests in traffic conditions that are roughly identical to the real-life conditions. It also advantageously makes it possible to vary over time, without adding or removing means to or from the network, the number of network entities simulated and thus perform increasingly complex simulations.

### DESCRIPTION OF FIGURES

Other characteristics and advantages may become apparent from the detailed description that follows, based on the appended figures which represent:

FIG. 1, a theoretical illustration of the structure of an ATN,

FIG. 2, a theoretical illustration of the simulation envisaged according to the invention,

FIG. 3, the structure of a standard ATN stack,

FIG. 4, the structure of the modified ATN stack according to the invention,

FIG. 5, an illustration of the addressing principle of a standard ATN stack,

FIG. 6, the addressing principle of a modified ATN stack according to the invention.

### DETAILED DESCRIPTION

The purpose of the description that follows is not to provide an exhaustive description of ATNs as they are in particular defined by the ICAO, or even to provide a complete description of the exchanges that exist between the various software layers that form an ATN stack. This information can be obtained from various definition and standardization documents published on the subject. Among these, there is the document “Comprehensive ATN manual—1st edition 2001—ICAO Doc 9739”, defining in particular the structure of an ATN, and defining the structure of an ATN exchange stack. The present document will be limited to defining how the architecture according to the invention differs from the standard architecture and how these differences respond to the problems raised.

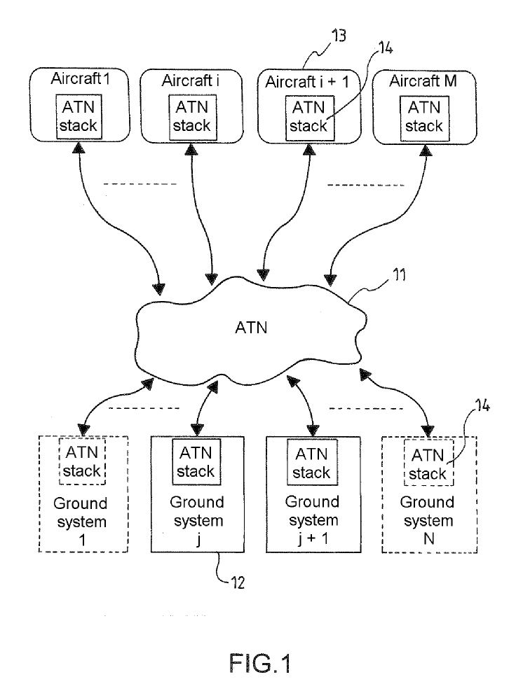

FIG. 1 is a block diagram showing the organization of an ATN. As can be seen from FIG. 1, an ATN is organized around a communication structure 11 to which terminal elements or ATN entities are interfaced. Since the subject is communications in the aeronautical field, there are in particular ground-based terminals 12 which can be of various types, such as, for example, traffic control centers, meteorological observation centers or even airline companies. There are also air terminals 13, in particular commercial airplanes or, more generally, aircraft. Each of these recognized ATN entities exchanges information with the other entities by means of an ATN stack 14 which manages, for each entity, both the information that it transmits and the information that it receives.

FIG. 1 shows just how complex the management of the information in such a structure can be for an entity. When it comes in particular to an air traffic control center to which is assigned a given air space zone, the quantity of information exchanged in particular with the aircraft 13 maneuvering in the zone, is great, bearing in mind that processing such a quantity of information that is by no means negligible requires the supervision of a human operator. When commissioning or testing such a system, it is therefore important to be able to determine whether this system has sufficient capability to guarantee the integrity of all the information exchanges that it needs to handle, in particular with all the aircraft located in the air space that it controls.

To perform such a test involves implementing simulations that reflect a real exchange situation as faithfully as possible. Now, such simulations themselves assume the implementation of simulated ATN entities, each entity being interfaced with the network by an ATN stack 14, the most obvious solution being to implement an ATN stack for each simulated entity. A simulation is thus, for example, obtained, for which each aircraft is simulated by a computation means having its own interface with the ATN network 11. This embodiment of a simulation test does, however, appear to be extremely difficult to implement given the quantity of interfaces to be used if the aim is to perform a simulation that approximates to a real-life situation for which the control system may exchange information with several hundred aircraft.

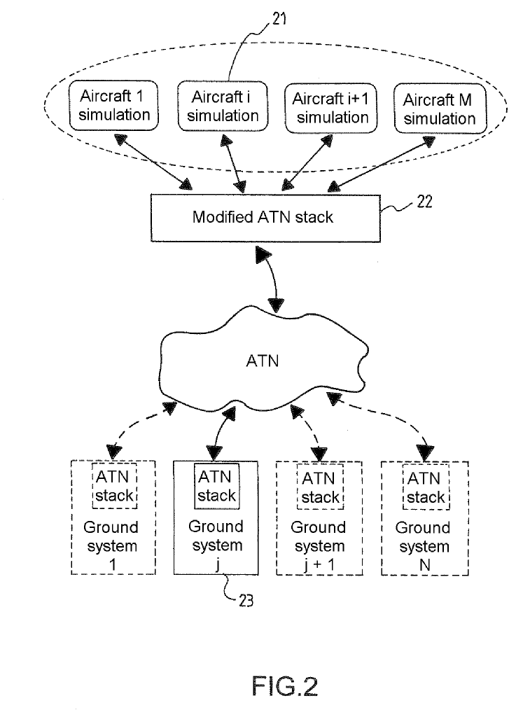

FIG. 2 diagrammatically shows the solution implemented by the invention. According to this solution, the simulations of the various ATN entities that are the aircraft are performed by computation means associated with a single network interface 22 consisting of an ATN stack modified for this purpose. This single interface enables the simulation means to exchange information with the control system 23 under test, like as many independent ATN entities.

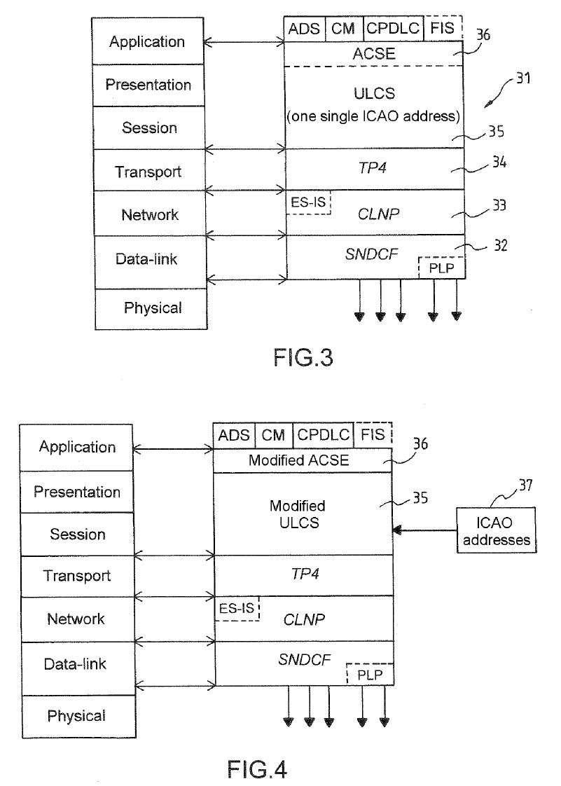

FIGS. 3 and 4 diagrammatically show the layered structure of the standard ATN stack and of the modified ATN stack. They can thus serve to introduce the description of the principle of the invention.

FIG. 3 shows the structure of a standard ATN stack 31, in light of a conventional exchange structure of OSI (“Open Systems Interconnection”) type.

In addition to the physical layer proper, an OSI stack conventionally comprises a “Data link” layer, a “Network” layer, and a “Transport” layer which marks the boundary between the purely physical layers and the logical layers of the structure. It also comprises a “Session” layer, a “Presentation” layer and an “Application” layer. FIG. 4 shows the structural equivalences that exist between an OSI stack and an ATN stack.

In the ATN stack, the functionalities of the “Data link” layer are provided by the “SNDCF” (“SubNetwork Dependent Convergence Functions”) layer 32. Similarly, those of the “Network” layer are provided by the “CLNP” (“ConnectionLess Network Protocol”) layer 33, whereas those of the “Transport” layer are provided by the “TP4” (“Transport layer class 4”) layer 34. The “ULCS” (“Upper Layer Communication Services”) layers 35 and “ACSE” (“Association Control Service Element”) layers 36 provide the functionalities of the “Session” and “Presentation” layers, and of the bottom part of the “Application” layer (layer 7a of the OSI model).

Regarding the object of the invention, there is no need to go into more detail on the structure and the function of the various protocol layers. However, for more detail, reference can be made to publications concerning the OSI protocol, and the standards and recommendations concerning the x ATN networks mentioned previously. In the context of the invention, only the ULCS and ACSE layers (35 and 36 respectively) are involved.

FIG. 4 repeats the drawing of FIG. 3, revealing the modified layers in the inventive ATN stack structure. As FIG. 4 shows, the layers 35 and 36 are modified so as to introduce into the logical layers of an ATN stack the recognition of the layer ICAO address as a parameter 37 involved in managing data crossing from the ACSE layer, which forms the interface with the various applications, to the transport layer TP4 and vice versa. The recognition of this additional parameter makes it possible to assign different identifiers to one and the same application in order to simulate multiple entities provided with this same application.

Thus, if, for example, a number of aircraft are to be simulated, it is essential to be able to simulate a CPDLC function for each simulated aircraft. Thanks to the invention, this simulation can be done simply by means of a single ATN stack, by assigning each simulated CPDLC application an identifier making it possible to determine both that the application is of CPDLC type and that it relates to a particular aircraft defined by its ICAO address.

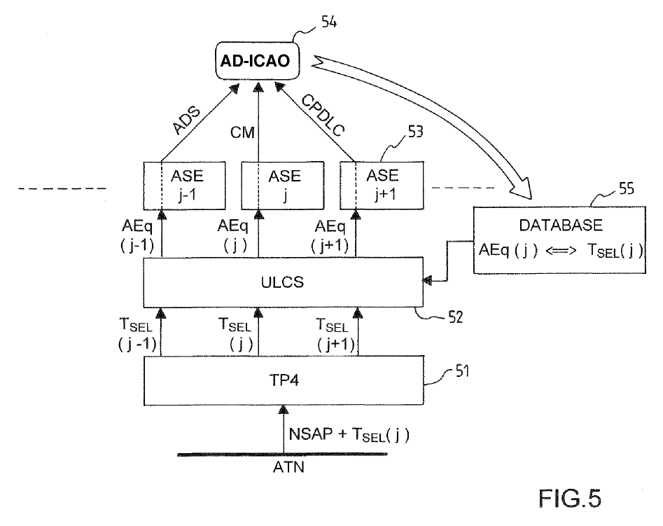

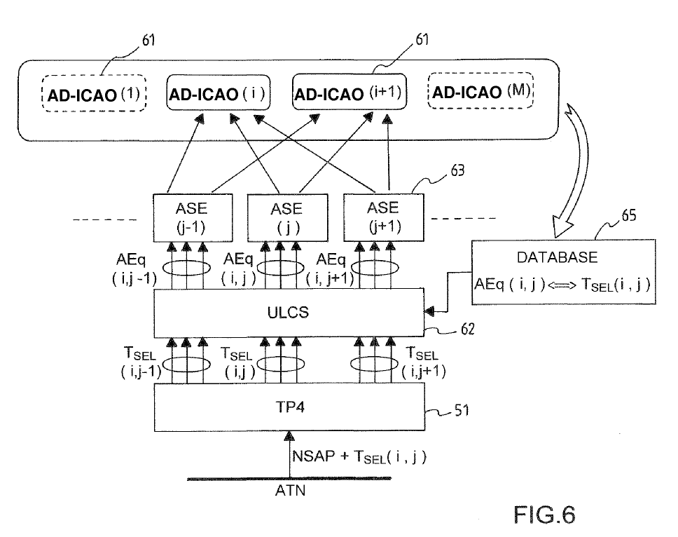

FIGS. 5 and 6, show the claimed invention in more detail. FIG. 5 shows in a simplified and functional way how the exchanges between the ATN network and the various applications that can be implemented by an ATN entity, of aircraft type for example, are normally conducted. As for FIG. 6, it illustrates how the same exchanges are simulated using an inventive modified ATN stack. In these two figures, the box entitled ULCS contains the ULCS layer and the ACSE layer. Similarly, the layers located between the ATN proper and the TP4 layer are not shown.

In the case of conventional operational service, illustrated by FIG. 5, the data exchanged between the ATN and the applications implemented by a terminal (a network entity) of aircraft type for example, are based on the uniqueness of the ICAO address assigned to the terminal.

At the TP4 transport layer 51, that is, under the ULCS logical layer, 52, the application implemented by the terminal is identified on the one hand by the NSAP (Network Service Access Point) identifier which represents the address of the ATN stack on the network, and on the other hand by the identifier T_{SEL} (Transport Selector) which represents the channel assigned to the application concerned. Thus, at the network level, a given application of a given terminal is identified by NSAP+T_{SEL}. The NSAP information is recognized at the level of the transport layer which processes and transmits the identifier T_{SEL} associated with the ULCS layer.

Above the ULCS layer, there are the application or ASE (Application Service Element) layers, 53, which dialog with the ULCS layer 52 via the ACSE interface layer. These ASE layers 53 make it possible to address the various applications implemented by a terminal through their identifiers AEq (Application Entity qualifier). Each identifier or qualifier therefore corresponds to the address of one of the applications of the terminal concerned, an ATN stack being used as an interface only for a single terminal 54, identified by the ICAO address assigned to it. Moreover, the identifiers AEq are represented by numbers having standardized values, the AEq identifier corresponding to the CPDLC application for an aircraft having, for example, the value 2.

To be able to interface a particular application with the ATN, it is therefore necessary to be able to associate its identifier AEq with the corresponding identifier T_{SEL} of the transport layer, the identifier T_{SEL} associated with the identifier AEq having any non-standardized value. The association operation is carried out by the ULCS layer.

In operational mode, this code conversion task remains relatively simple. In practice, a transmission channel opened to transfer information from a given application to another terminal, a control center for example, will be dedicated exclusively to the application concerned for the terminal concerned. Thus an application j, assigned the identifier Aeq(j), of a terminal which is itself assigned the ICAO address AD_ICAO, will be associated at the network level with an NSAP identifier and an identifier T_{SEL}(j). The association is made at the ULCS level by means of a database 55 which sets up the correlation between the identifier AEq(j) of a given application j and the identifier T_{SEL} corresponding to the channel opened for this application at the ATN level.

Thus, for example, access from a ground control center to a given application j implemented by an aircraft will be reflected in the sending of the identifier T_{SEL}(j) over the network by the ground center. The TP4 layer, 51, will transmit the identifier T_{SEL}(j) to the ULCS layer 52, the role of which is to associate an identifier AEq(j) designating the application j with this identifier T_{SEL}(j). This identifier accompanying the information exchanged by the application j and the ground center will enable the information to be recognized by the ASE corresponding to the application j and only by that ASE.

FIG. 5 illustrates this addressing for the particular example of the ATN stack of an aircraft. In this example, the three applications j−1, j, and j+1 represent three particular applications: the ADS (Automatic Dependent Surveillance), CM (Context Management) and CPDLC (Controller-Pilot Data Link Communication) applications.

To enable a number of simulated terminals 61 to be interfaced by a single stack, the inventive ATN stack has a modified exchange structure. As can be seen in FIG. 6, this modification consists in replacing the bottom parts of the ASE layers in such a way that each ASE corresponding to a given type of application (ADS, CM, or CPDLC for example) has a number of identifiers AEq equal to the number of aircraft that can be simulated. The modification also entails modifying the standard ULCS layer to form a modified ULCS layer 62 capable of associating with each identifier AEq(i, j) transmitted by the modified ASEs, AEq(i, j) corresponding to the application j implemented by the aircraft i, an identifier T_{SEL}(i, j) corresponding to a channel opened for the application j of the simulated terminal i.

The ULCS layer 62 uses an enriched database 63 which makes it possible to determine the identifier AEq(i, j) corresponding to a given identifier T_{SEL}(i, j). This database 63 enables the ULCS to map the unique identifier T_{SEL}(i, j) to the application j implemented by the simulated terminal i. Consequently, this application j will be identified at the ATN network level by the set of the two identifiers NSAP and T_{SEL}(i, j).

The enriched database 63 enables the ULCS to establish a link correlation between the identifier AEq(i, j) of a given application j of a given terminal i and the identifier T_{SEL}(i, j). It thus enables a given ASE, dedicated to a particular application j, to have as many communication channels as there are entitles i to be simulated that are implementing this application, each of these entities being identified by its address AD_ICAO(i). This way, the invention enables a large number of entities to be simulated through a single ATN stack.

This modified database is completed from defined simulation scenarios. Thus, the more entities there are simulated, the greater the size of this database.

The modified database 63 can, in particular, be a parameterized and downloadable element. Thus, one and the same ATN stack can be used to implement different test scenarios. The change of scenario is reflected simply at the stack level by reading from a new downloaded database.

In practice, a test or simulation scenario can, for example, correspond to a given software package implemented by a computer. For the requirements of the dialog with other real or simulated entities through the ATN, this software can, in particular, use a generic routine implementing the ATN stack, this routine comprising, at the level of a ULCS layer management subroutine, access to a downloadable database containing in particular the mapping table correlating the identifiers T_{SEL}(i, j) and the identifiers AEq(i, j). In this case, one task of the test or simulation software consists, to this end, in adding to the database 63 according to the number of applications and entities simulated. This way, on each access request from an application to the ATN, the subroutine that manages the ULCS layer establishes the match between the identifier AEq of the ASE application layer and the identifier T_{SEL} of the transport layer and lower layers. A communication channel is thus set up.

As can be seen from the above description, implementing the invention requires not only the use of an enriched database 63, but also modification of the lowest sublayers of the ASE layers, a modification that makes it possible, for a given application type, for an identifier AEq to be assigned to each of the simulated entities.

In as much as the ATN stack is used for test and simulation procedures, it is possible to assign each identifier AEq a purely arbitrary value, proceeding, for example, in ascending order. It is thus possible to assign a given ASE layer n identifiers AEq(i, j), the values of which run in sequence, and the next ASE layer identifiers AEq(i, j), the values of which immediately follow on from the first. However, one advantageous implementation of the ATN stack according to the invention consists in assigning each ASE a possible identifier AEq value field and give each identifier a value taken from this field and dependent on the rank i assigned to the simulated entity. The size of the field can be a parameter whose value is determined by the test procedure carried out.

Thus, if we consider a test procedure on a ground system, a ground control center for example, this test procedure can include the simulation of several hundred aircraft, each aircraft implementing standard applications such as those cited previously. The inventive stack can then comprise as many ASE layers as there are application types (CM, CPDLC, etc.), each application interfaced by a given ASE being associated with an identifier AEq defined by the following relation:

AEq(i,j)=AEq(j)·Nb_Entities+i [1]

In the relation [1], AEq(i, j) represents the identifier of the function j implemented by the simulated entity i, AEq(j) being the identifier of the application j for a standard ATN stack. In real operation, the value of the identifier AEq(j) corresponding to a given application j is, as has already been stated, a standardized value, the CM application having, for example, the identifier AEq(CM)=2.

Nb_Entities represents the maximum number of entities simulated.

The number i assigned to a simulated entity identified by AD_ICAO(i) is dependent on the chronological order of storage of the entities while the test procedure is running.

Thus, for a test procedure that can involve up to 1000 aircraft, Nb_Entities would have the value 1000, and the identifier of the CM application implemented by the simulated entity 123 will have the value:

AEq(123,CM)=2·1000+123=2123

This way of implementing the invention, consisting in assigning each identifier AEq(i, j) a value defined by relation [1], presents the advantage of enabling all the values taken by the identifiers AEq to be stored in a table of a size that can be parameterized by the number of simulated entities Nb_Entities. It also advantageously makes it possible to link the value of the identifier associated with a given application to the number of the simulated entity and to the standardized value taken by the identifier of the application in real operation. Knowing AEq(i, j) and the number Nb_Entities, AEq(j) and i can then be determined simply by the following relations:

AEq(j)=E(AEq(i,j)/Nb_Entities) [2]

I=AEq(i,j)modulo Nb_Entities [3]

In relation [2], “E” represents the “integer part” function.

In this embodiment of the invention, the database enabling the ULCS layer to associate T_{SEL}(i, j) with AEq(i, j) advantageously takes the form of a simple descriptor file generated by the program implementing the simulation procedure and able to be read by the ULCS function of the routine that implements the ATN stack. This file contains, for each application, only the information necessary to associate an identifier T_{SEL} with the identifier AEq corresponding to this application; the nature of the application concerned, and its attachment to a given simulated entity can advantageously be deduced from the value of the identifier AEq.

The embodiment described in the above paragraphs, although presenting numerous advantages, is described in this document purely as a nonlimiting example. Other embodiments of a modified ATN stack according to the principle of the invention can obviously be considered.

1. An architecture for simulating entities on an ATN, each simulated entity, i, implementing applications j involving exchanges of information via the ATN, through the intermediary of an ATN exchange stack, wherein the structure of the ATN exchange stack has been modified to allow all the simulated applications to be interfaced through a single ATN stack with each application being associated at the network level with a unique identifier and each network identifier corresponding to a single application.

2. The architecture for simulating entities on an ATN as claimed in claim 1, wherein said modified ATN stack comprises modified ASE application layers for interfacing several applications of the same type j, each application being implemented by a given simulated entity i, a modified ASE layer assigning each application j implemented an identifier AEq(i, j) dependent on the application j implemented and the simulated entity i that is implementing it.

3. The architecture as claimed in claim 2, wherein said modified ATN stack further comprises a modified ULCS application layer for setting up the associations of the application identifiers AEq(i, j) with network identifiers T_{SEL}(i, j), each identifier T_{SEL}(i, j) corresponding on a one-to-one basis to the corresponding identifier AEq(i, j).

4. The architecture as claimed in claim 3, wherein said modified ULCS layer uses a database parameterized by the identifier i of the simulated entity and the identifier j of the application concerned.

5. The structure as claimed in claim 4, also wherein said database is represented by a descriptor file loaded by the software implementing the test or simulation scenario concerned and accessible to the subroutine that manages the ULCS layer.

6. The architecture for simulating entities on an ATN as claimed in claim 1, wherein application j is implemented simultaneously by a number of simulated entities i.

7. An architecture for simulating entities on an ATN, each simulated entity, i, implementing applications j involving exchanges of information via the ATN, through the intermediary of an ATN exchange stack, wherein the structure of the ATN exchange stack has been modified to allow all the simulated applications to be interfaced through a single ATN stack with each application being associated at the network level with a unique identifier and each network identifier corresponding to a single application;
wherein said modified ATN stack comprises modified ASE application layers for interfacing several applications of the same type j, each application being implemented by a given simulated entity i, a modified ASE layer assigning each application j implemented an identifier AEq(i, j) dependent on the application j implemented and the simulated entity i that is implementing it;
wherein said modified ATN stack further comprises a modified ULCS application layer for setting up the associations of the application identifiers AEq(i, j) with network identifiers T_{SEL}(i, j), each identifier T_{SEL}(i, j) corresponding on a one-to-one basis to the corresponding identifier AEq(i, j); and
wherein application j is implemented simultaneously by a number of simulated entities i

8. The architecture as claimed in claim 7, wherein said modified ULCS layer uses a database parameterized by the identifier i of the simulated entity and the identifier j of the application concerned.

9. The structure as claimed in claim 8, also wherein said database is represented by a descriptor file loaded by the software implementing the test or simulation scenario concerned and accessible to the subroutine that manages the ULCS layer.

10. An architecture for simulating entities on an ATN, each simulated entity, i, implementing applications j involving exchanges of information via the ATN, through the intermediary of an ATN exchange stack, wherein the structure of the ATN exchange stack has been modified to allow all the simulated applications to be interfaced through a single ATN stack with each application being associated at the network level with a unique identifier and each network identifier corresponding to a single application; and
wherein said modified ATN stack comprises modified ASE application layers for interfacing several applications of the same type j, each application being implemented by a given simulated entity i, a modified ASE layer assigning each application j implemented an identifier AEq(i, j) dependent on the application j implemented and the simulated entity i that is implementing it.

11. The architecture as claimed in claim 10, wherein said modified ATN stack further comprises a modified ULCS application layer for setting up the associations of the application identifiers AEq(i, j) with network identifiers T_{SEL}(i, j), each identifier T_{SEL}(i, j) corresponding on a one-to-one basis to the corresponding identifier AEq(i, j).

12. The architecture as claimed in claim 11, wherein said modified ULCS layer uses a database parameterized by the identifier i of the simulated entity and the identifier j of the application concerned.

13. The structure as claimed in claim 12, also wherein said database is represented by a descriptor file loaded by the software implementing the test or simulation scenario concerned and accessible to the subroutine that manages the ULCS layer.

14. The architecture for simulating entities on an ATN as claimed in claim 10, wherein application j is implemented simultaneously by a number of simulated entities i.
